(19) United States
(12) Patent Application Publication
(10) Pub. No.: US 2003/0057227 A1
(43) Pub. Date: Mar. 27, 2003

(54) Vending machine

(76) Inventor: Kai Janssen, Edewecht (DE)

Correspondence Address: ALIX YALE & RISTAS LLP, 750 MAIN STREET, SUITE 1400, HARTFORD, CT, 06103, US

(21) Appl. No.: 10/181,862

(22) PCT Filed: Jan. 17, 2001
(86) PCT No.: PCT/EP01/00505

(30) Foreign Application Priority Data
Jan. 20, 2000 (EP) 00101083.4

(51) Int. Cl. B65H 1/00; G07F 11/00

(52) U.S. Cl. 221/92

(57) ABSTRACT

A vending machine having a large number of magazine compartments (18) which are arranged in an endless row and are moved in order to connect to a delivery path. A simplification in mechanical and control terms is achieved by a plurality of magazine drums (4) which can be driven in rotation and each have a row of magazine compartments (18) on the periphery being provided, to which in each case a delivery opening (30) opening into the delivery path is assigned. The magazine drums, which are open at the bottom, expediently lie on a magazine plate which contains the delivery openings (30)

The invention relates to a vending machine for unit products, for example packed snack sausages.

A known vending machine (U.S. Pat. No. 3,712,507, U.S. Pat. No. 2,384,863) uses as a magazine a plurality of magazine drums arranged one above another on a common shaft and each having at the periphery a row of magazine compartments. Underneath each magazine drum there is a magazine plate, which closes the magazine compartments, which are open at the bottom, and only. at one peripheral point has a delivery opening, whose form approximates that of the magazine compartments. If, during the rotation of a magazine drum, a filled magazine compartment comes over the delivery opening, then the product located in the compartment falls out downward through the delivery opening. The delivery openings of all the magazine plates located one above another are aligned vertically with one another. They form a fall shaft, which is bounded by the edges of the delivery openings and the walls of the magazine compartments of the individual drums. The height of the fall shaft corresponds to the height of the stack of magazine drums and—depending on the magazine capacity and number of drums—can be considerable. The known vending machine is not suitable for delicate products. In addition, it has the disadvantage that the fall shaft at each level forms a plurality of horizontal gaps between the walls of the magazine compartments involved and the magazine plates, in which gaps package edges could be caught. This applies even more when—as is inevitable in practice—not all the magazine drums are set exactly to the delivery openings. If, for such reasons, a jam occurs at any point, the device is incapable of operating. The same result occurs when any magazine drum is inhibited from rotating. This is because only a single drive is provided for all the drums. The known machine is very complicated to produce, since these disadvantages can only be kept within limits given high production accuracy. When used for sausages, there is the additional disadvantage that—in accordance with the length of the products—the individual magazine drums have to be relatively high and therefore, with regard to the limited overall height of the machine, only a low number of magazine drums can be arranged one above another, which restricts the holding capacity. The axial distances between the drums and the magazine plates have to be coordinated accurately with one another, since otherwise, given too great a distance between a drum and the associated magazine plate, goods can be clamped in between them or, given too small a distance, mutual contact and an excessively high drive resistance can occur. This increases the expenditure on construction.

The invention is based on the object of providing a vending machine of this type, as specified in the preamble of claim 1, which is uncomplicated and can be operated without faults. This object is achieved by the features of claim 1 and preferably those of the subclaims.

The fact that each magazine drum, with its own drive and own delivery opening, forms a unit independent of the other magazine drums, means that complicated mutual coordination is not required. In addition, any faults in one magazine drum do not have a detrimental effect on the serviceability of the other magazine drums. The delivery path does not contain any fall shaft comprising a large number of parts to be aligned accurately with one another. Instead, the arrangement of the delivery openings belonging to the various magazine drums above a funnel ensures a great degree of freedom in the selection of the dimensions and the tolerances. Accurate location of the delivery openings above the funnel is not a concern here. This provides the possibility of moving the magazine plate together with the drums located on it from the operating position into a filling position by means of a simple device, on which no significant accuracy requirements are placed. The overall result is a vending machine which is uncomplicated to produce, can be operated easily and is operationally reliable.

Although a vending machine is known (EP-A 480 857), in which a plurality of magazines is arranged above a magazine plate, these are not rotatable magazine drums but magazine shafts for delivering stacked individual parts, which are then brought from the respective magazine shaft to a delivery opening by a conveying disk which is integrated in the respective magazine plate. This operating principle demands that in each case the lowest product, on which the products located above are resting, has to be separated from a magazine shaft in order to be picked up in the conveying disk. Without complicated implementation devices, this then functions only when the products to be delivered are shaped in exactly the same way. Even in the case of pizzas, for which the known device is conceived, irregularities result, however, which barely permit fault-free operation to be hoped for. In addition, apart from a complicated design, the known device has the disadvantage that a delivery fault on a magazine shaft also prevents delivery from the other magazine shafts which are assigned to the same conveying disk. In order to make filling easier, the magazine plate with the magazine shafts is intended to be pivotable. Whether and how this desire could be satisfied in design terms remains open. In any case, this would have to be very difficult and complicated, since the conveying and delivery devices integrated into the magazine plate have to be included in the ability to pivot, without their functionally accurate coordination with one another and with the adjacent parts of the device being impaired.

It is also known (FR-A 2 692 769), to arrange a plurality of magazines above a funnel leading to their delivery. In this case, each magazine comprises a plurality of magazine shafts, in which sausages are stacked horizontally one above another. By means of a motor-driven slider, in each case the lowest sausage in each shaft can be transferred into an intermediate shaft, in which they are stacked one above another, in order to be able to be delivered individually via a further, motor-driven slider. Such a slider design can be used only when it is exclusively products of exactly the same, unchanging dimensions which are to be marketed, which is already a problem in the case of unpacked sausages and, for example, makes it impossible to use the device for sausages welded into bags. In addition, the practical use of such a device for unpacked sausages fails on the impossibility of cleaning and filling it with tolerable effort.

The invention provides for the magazine drums having magazine compartments that are open at the bottom to be arranged on the magazine plate containing the delivery openings. If a drum is moved step by step by the angular spacing of the magazine compartments, then the latter pass one after another into the area of the delivery opening, through which the product contained in the respective magazine compartment falls simply into the delivery path on account of the force of gravity. An arrangement with a vertical drum axis is particularly suitable for this purpose; however, this vertical arrangement is not absolutely necessary.

In each case a plurality of magazine drums, preferably even all the magazine drums, are arranged on the same magazine plate. This results in a particularly simple design, particularly since a common funnel is provided to catch the products falling out of the delivery openings, and forms part of the delivery path. It goes without saying that the delivery openings in the plate are arranged in such a way that they are located in the catching area of the funnel.

The arrangement of the magazine drums on a common plate also has the advantage that the filling and maintenance of the magazine drums and of the associated drives can be made easier by the fact that the plate as a whole is moved out of its operating position, in which it is less easily accessible, into a filling and maintenance position. In this connection, the use of a funnel that catches the products is particularly advantageous, since it assumes no precision in the mutual arrangement of the plate and of the funnel. In addition, the use of special and, if necessary, permanently connected transfer devices can be dispensed with.

Use if preferably of seven magazine drums, which are arranged in a group of six around a centrally arranged drum, since this therefore results in the best utilization of space and, when the delivery openings of the outer magazine drums are in each case arranged on their side facing the center, the funnel needs to have the smallest diameter. However, it goes without saying that the principle also permits other arrangements.

The possibility of assigning a separate product code to each compartment in an endless magazine conveyor is known. This assumes that the control device is also informed as to which product is located in which compartment, which makes both filling and control complicated, and also provokes errors. The assignment according to the invention of a drum to a product in each case contributes to avoiding errors in filling. In addition, the control is simpler if it can in each case relate to entire drums, that is to say groups of compartments instead of individual compartments.

As a rule, during the filling operation, the existing drums will be left in the vending machine and only the empty compartments will be refilled. However, the invention also provides the possibility of replacing drums as a whole. The wholly or partly empty drums are removed and replaced by drums filled at the factory. In this case, these can be provided with a code which in each case informs the control device which product they contain.

The assignment of different products to different drums also has the advantage that the control signals which lead to the delivery of a product from the magazine do not have to be assigned to individual compartments, but can be assigned to the drums. This does not mean that all the drums have to contain different products. However, in order to be able to offer as many different products as there are drums, the device available for the selection by the customer is expediently designed in such a way that the number of possible selections corresponds to the number of drums.

If a plurality of drums contain the same product, about which the control device is also informed in a suitable way, the select command input by the customer is expediently forwarded in a product-specific manner instead of a drum-specific manner, the control device determining from which drum the product is removed. For example, if of seven drums five drums are filled with product A and two drums with product B, and if seven selection devices are available to the customer, of which, in accordance with the drum filling, five are assigned to product A and two to product B, then each select command for product A or B will be assigned by the control device to the respective product and not to a specific drum, irrespective of which of the various selection devices said command was used to input. This has the advantage that, irrespective of which selection device was used to input the command, the control device can determine the order in which the items of one and the same product are removed from the various drums. As a result, it is possible to ensure approximately identical residence times. For example, it may be expedient for the successive removal of items of a product to drive the drums containing the product cyclically, in order that removal takes place uniformly from each drum. Furthermore, it may be expedient that, after a previously only partly emptied drum has been filled, those items which were already present before the filling are output first. The simplest way of achieving this is by the latter being located closest to the removal point following the filling of the drums, provided the rotational position of the drums is not changed during the filling.

Although it is conceivable to communicate the level of the individual magazine compartments automatically to the control device, so that the latter is capable of steering a filled compartment to the delivery opening in each case, it is simpler if, according to the invention, a delivery sensor is provided in the delivery path, and indicates the delivery of a product from the magazine. In this case, the control device is configured in such a way that when delivery from a drum is selected, the latter is caused to make a rotational step corresponding to the chamber spacing. If a delivery signal from the delivery sensor is not received within a specific time interval, then it is taken as a sign that the compartment connected to the delivery path was empty. This causes the control device to make a further such rotational step, until ultimately the delivery of a product is determined by the delivery sensor. This avoids the situation where no product is delivered, should magazine compartments inadvertently not have been filled.

The complete emptying of a drum can be determined by the control device by the number of products removed from the individual drums or the number of rotational steps covered by the drum since the last filling being counted.

If a heating device is provided in the delivery path and is provided with a presence sensor for a product, this presence sensor can simultaneously fulfil the tasks of the aforementioned delivery sensor.

The design is particularly simple if no particular bearings for the drums are provided, but if their lower end faces are permitted simply to slide on the plate surface. If the drums consist of plastic and the plate of steel, the friction is negligible as compared with the friction between the plate and the products in the compartments.

The use of a funnel is not a problem if the product items are of compact design, that is to say one of their dimensions is not significantly larger than the other two. However, in the case of elongate products, such as sausages, it must be ensured, by means of a suitable funnel shape, that they cannot lie transversely therein. According to the invention, this risk is countered by the angle of inclination of the funnel wall increasing toward the mid-axis. The length of the section of a tangent drawn in a radial plane at an arbitrary point on the funnel surface should, between the tangent point and the point of intersection with the opposite funnel surface, always be longer than two thirds of the length of a product. It is expediently greater than three quarters of the length of a product. These features based on the funnel shape will if necessary provide protection independently of the features explained previously.

The invention will be explained in more detail below with reference to the drawings, which illustrates an advantageous exemplary embodiment and in which:

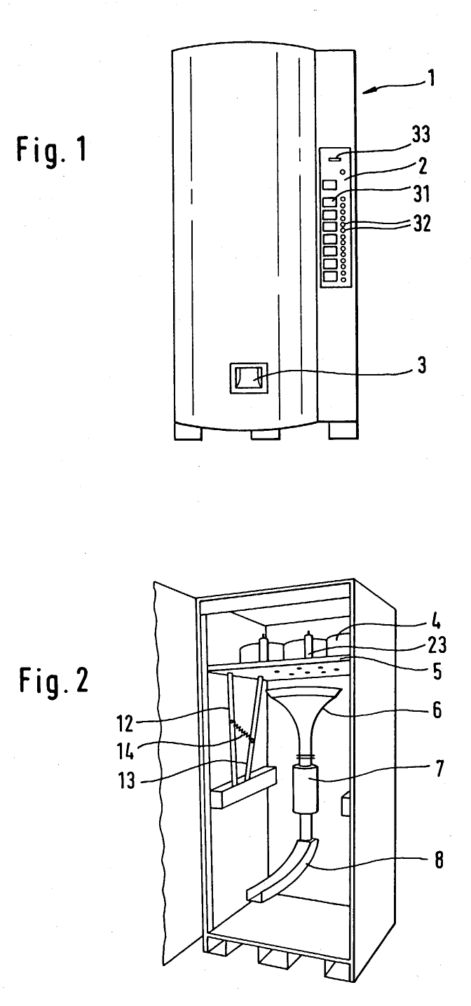

FIG. 1 shows a front view of the device in the closed state, FIG. 2 shows a view of the device obliquely from the

front in the opened state and in the operating position,

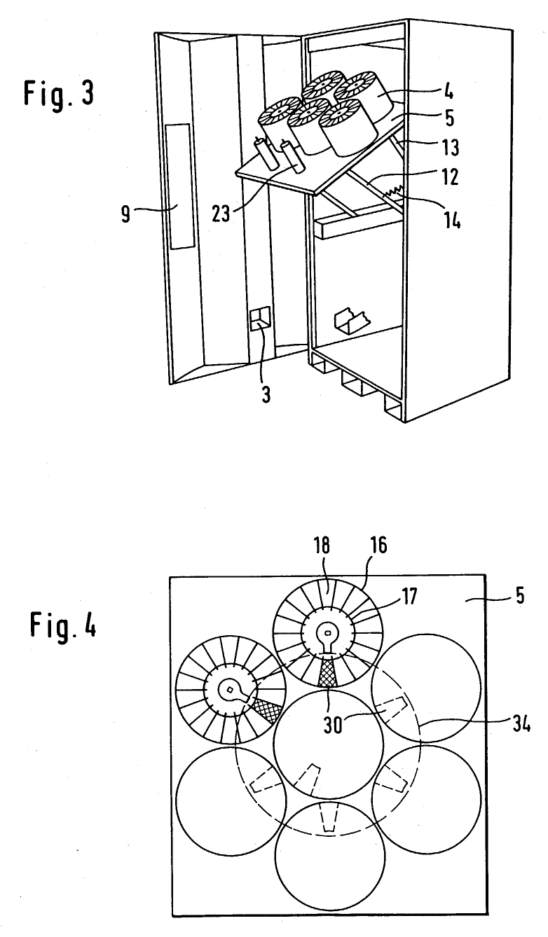

FIG. 3 shows a view of the device obliquely from the front in the filling position,

FIG. 4 shows a plan view of the magazine,

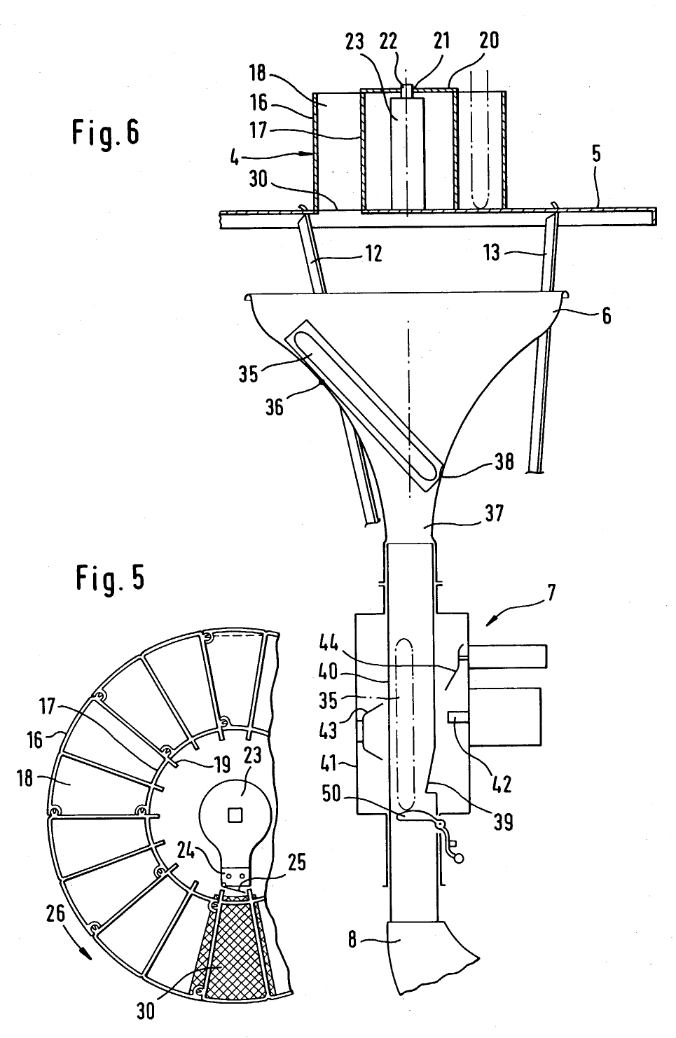

FIG. 5 shows a plan view of an individual drum,

FIG. 6 shows a schematic sectional illustration of the significant functional elements and

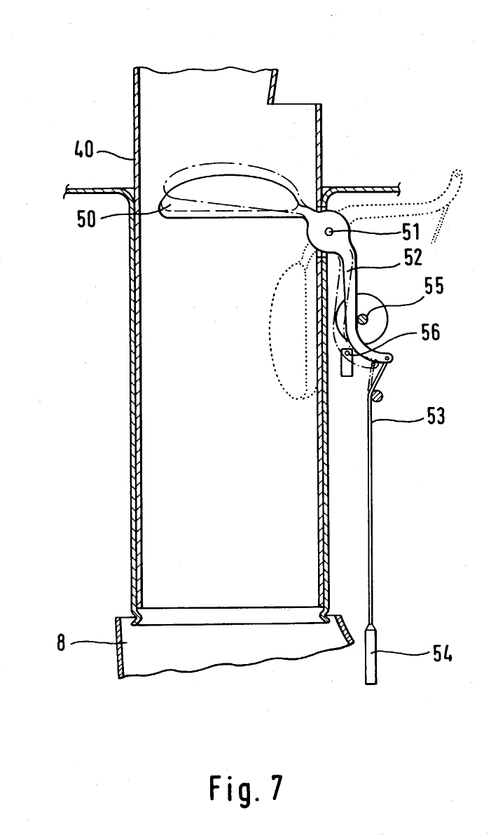

FIG. 7 shows a section through the delivery path in the area of the blocking element.

The vending machine is enclosed by a cabinet-housing 1. At its front, this has an operating panel 2 and a removal tray 3 for the removal of the selected product. If the door forming the front side is opened, then the result is the view of FIG. 2, in which, for simplicity, those structural parts which are used to hold the functional parts described below have been left out.

At the uppermost point within the cabinet there is the magazine, which is formed by a plurality of magazine drums 4 on a magazine plate 5. Provided underneath the magazine plate 5 is a funnel 6, which catches the product selected and released from one of the magazine drums 4 and guides it into a heating device 7, from which it passes via a chute 8 into the removal tray 3. The delivery path formed by the funnel 6 the heating device 7 the chute 8 and the removal tray 3 is referred to in summary as the delivery path. The functional interplay between the operating elements of the panel 2 and the magazine and discharge path is determined by a control device 9.

The magazine plate 5 rests on two pairs of swinging supports 12, 13 which, together with a spring 14, permit two end positions for the magazine plate 5 in a bistable manner, namely firstly the approximately horizontal operating position shown in FIG. 2 inside the cabinet, and the position illustrated in FIG. 3, displaced forward out of the cabinet and inclined, in which the magazine is more easily accessible for filling and maintenance.

The magazine plate 5 accommodates seven magazine drums 4, namely a centrally arranged magazine drum and six magazine drums placed uniformly around it. This results in a good utilization of space. Between a cylindrical outer wall 16 and a cylindrical inner wall 17, each magazine drum 4 contains a closed ring of magazine compartments 18, each of which has the same width in the peripheral direction. The inner wall 17 bears inwardly projecting protrusions 19, which are in each case coordinated locally with a magazine compartment. The magazine compartments 8 are open at the top and bottom.

The space enclosed by the inner wall 17 is open at the bottom, while it is covered at the top by a plate 20 which, at the center, contains a coupling opening 21 which is square in the example illustrated.

The magazine drums lie on the magazine plate 15 and are centered and driven in rotation by a coupling pin 22, which engages in a fitting manner in the coupling opening 21 and protrudes upward from a drive pillar 23. This drive pillar contains a geared motor, whose output shaft is connected to the coupling pin 22. Two such drive pillars 23 are shown in FIGS. 2 and 3, without the magazine drums 4 to be placed on them.

In FIG. 5, which shows the arrangement of magazine 4 and drive pillar 23 with the plate 20 taken off, it can be seen that the drive pillar 23 bears a limit switch 24 with a switch sensor 25. The latter is arranged in such a way that it interacts with the inner protrusions 19 on the magazine drum and, when the magazine drum 4 is rotated in the direction of arrow 26, in each case outputs a position signal when one of the magazine compartments 18 is located above an openings 30 in the magazine plate 5, indicated by cross hatching in FIG. 5. In this position, the rotary drive is stopped, so that the result is a step-by-step rotary advance of the drum.

On the operating panel 2, each magazine drum is assigned a label 31 which identifies the product respectively contained. In addition, beside each of these labels 31 there are two push buttons 32, by using which the customer can indicate whether he wishes to have the respective product cold or heated. As soon as said customer has selected a product and its temperature state by inserting money into the slot 33 and selecting one of the buttons 32, the control device 9 arranges for rotation of the relevant magazine drum 4 in the direction of arrow 26 until a filled magazine 18 is located above the delivery opening 30. The product then falls through the opening 30 into the delivery path. Further control details have been explained above or will be explained further below.

The delivery openings 30 are located within the catching circle 34 (FIG. 4) of the funnel 6. The product falling out of any delivery opening 30 is therefore caught securely by the funnel 6.

If the products are elongate, such as the snack sausage 35 contained in a foil pack and indicated at 35 in FIG. 6, it must be ensured that it does get caught at the transition from the conical funnel part to the narrow spout 37. To this end, the angle of inclination of the funnel wall increases as it increasingly approaches the mid-axis 38 of the latter. Should a product, as shown in FIG. 6, have simultaneous contact with two opposite funnel sides, then the selection of the geometric relationships ensures that the section between that point 36 at which the product rests on one side, similar to a tangent, and the opposite point 38 is always significantly longer than the section of the product on the other side of the point 36. As a result, the product is pivoted as a result of the dead weight of its longer section into a position closer to the axial direction, in which it can easily follow the further delivery path. These geometric relationships are in accordance with claim 11, the point 36 at which the elongate product rests on the funnel wall forming the tangent point, and the point 38 at which the end of said product rests on the opposite wall forming the point of intersection of the tangent with this opposite wall.

In the delivery path, there follows the heating device 7, in which said path is formed by a tube 40 made of a suitable dielectric, for example plastic. This tube 40 is surrounded by a circular resonator 41 for microwaves, into which the antenna 42 of a magnetron projects. Suitable nonmoving reflectors 43 and/or moving reflectors 44 can be provided in order to ensure a uniform energy distribution in the area of the product 35, indicated by dash-dotted lines.

The position of the product is determined by a flap 50, which is always closed when a product is let out of the magazine. The product is therefore caught in the heating station in every case.

As FIG. 7 shows, the flap 50 is mounted such that it can be pivoted about a horizontal axis at 51 close to the wall of the tube 50, in order firstly to be able to assume the blocking position and secondly to be able to assume the opening position indicated by a dotted line, in which the leaf of the flap is parallel to the tube wall and rests approximately on the latter, in order to leave a maximum passage cross section free. Above the flap, the tube 40 contains an internal projection 39, which leads the project past the opened flap 50. On the other side of the pivot 51, the flap is connected to an arm 52, whose end bears a weight 54, directly or via a filamentary connection 51. Instead of this, the flap could also be connected to a spring. The weight 54 or the spring is dimensioned and arranged in such a way that the flap 50 is consequently held securely in the blocking position as long as it is not loaded by the product. On the other hand, the weight is sufficiently low that the flap can be opened securely under the weight of the product, in order to let the latter through. In order that the product is held firmly for some time in the heating device, a magnetic bolt 55 is provided which, in the state indicated in FIG. 7, holds the flap lever 52 firmly in the blocking position and can be withdrawn (transversely with respect to the plane of the drawing) in order to release said flap lever 52.

As long as the flap 50 is unloaded, it is in the end position indicated by dash-dotted lines. The magnetic bolt 55 is arranged at a certain distance from the position in which the flap lever 52 is located in its end position. As soon as the flap is loaded by the product, it therefore pivots to such an extent that it is firmly held by the bolt 55, into the position shown by continuous lines. The difference between these two positions (shown by dash-dotted and continuous lines) is used to monitor the presence of the product. For this purpose, a sensor 56, for example a light barrier or a magnetic switch, is arranged in that area in which the flap lever 52 is located in its end position (dash-dotted). The switching state of this sensor changes as soon as the flap passes from its end position shown by dash-dotted lines into the locking position shown by continuous lines. The signal which the sensor 56 outputs in the latter case is evaluated by the control device as a sign of the presence of a product.

The signal is firstly important for the operation of the heating device 7. Only when there is a presence signal does the control device permit the heating device to be switched on. The signal is also important for the control of the magazine, since it indicates that a product has been delivered; it therefore forms a delivery signal, which is used by the control device for the control of the magazine. As soon as a customer has requested a product, the drum containing the product is rotated step by step until the delivery signal is received.

If the customer has requested the product cold, then the flap 50 is opened immediately after the arrival of the presence/delivery signal, by the magnetic bolt 55 being withdrawn. If said customer has requested said product hot, then the magnetic bolt 55 remains closed initially. The heating device is switched on for a predetermined time period. After that, a further specific time period is allowed to elapse until the bolt 55 is withdrawn, in order to permit accompanying phenomena which may be associated with the heating (for example inflation of the pack) to decay before the product is released for removal.

1. A vending machine having a plurality of magazine drums (4) which can be driven in rotation and which, on the periphery, have a row of magazine compartments (18) that are open at the bottom and are arranged on a magazine plate (5) which has a delivery opening (30) in the case of each magazine drum (4) and leads to a delivery path (6, 7, 8), characterized in that all the magazine drums (4) are arranged on the same magazine plate (5), which can be moved between an operating position and a filling position and whose delivery openings (30), in the operating position, lie above a funnel (6) which forms part of the delivery path.

2. The vending machine as claimed in claim 1, characterized in that a selection device (32) is in each case assigned to a magazine drum (4) or group of magazine drums.

3. The vending machine as claimed in claim 1 or 2, characterized in that a control device (9) is provided which, when delivery from a drum (4) is selected, causes the latter to make a rotational step corresponding to the chamber spacing and, if a delivery signal from a delivery sensor (56) placed in the delivery path is not received within a specific time interval, causes a further rotational step, etc.

4. The vending machine as claimed in claim 3, characterized in that the delivery flap (50) of a heating device (7) provided in the delivery path is formed as a delivery sensor or is provided with the delivery sensor (56).

5. The vending machine as claimed in one of claims 1 to 4, characterized in that the magazine drums (4) slide directly on the magazine plate (5).

6. The vending machine as claimed in one of claims 1 to 5, characterized in that the angle of inclination of the funnel wall increases toward the mid-axis (38).

7. The vending machine as claimed in claim 6, characterized in that the length of the section of a tangent drawn in a radial plane at an arbitrary point (36) on the funnel surface is, between the tangent point (36) and the point of intersection (38) with the opposite funnel surface, always longer than two thirds of the length of a product (35).
